(19) United States
(12) Patent Application Publication
(10) Pub. No.: US 2009/0319710 A1
(43) Pub. Date: Dec. 24, 2009

(54) DEVICE AND METHOD FOR LOCKING TOUCH SCREEN

(75) Inventor: YOUNG-WAY LIU, Tucheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/192,093

(22) Filed: Aug. 14, 2008

(30) Foreign Application Priority Data
Jun. 19, 2008 (CN) 200810302227.6

(51) Int. Cl. G06F 12/14

(52) U.S. Cl. 710/200

(57) ABSTRACT

An electronic device includes a central processing unit (CPU), a touch screen, a locking module, and a locking button. The locking module is configured for storing a locking program. When the touch screen is forced into an unlocked status, operation of the locking button is capable of causing the CPU to instruct the locking module to activate the locking program to lock the touch screen.

### BACKGROUND

1. Field of the Invention

The present invention relates to electronic devices having touch screens, and particularly to an electronic device having a touch screen locking function and a touch screen locking method thereof.

2. Description of Related Art

Nowadays, touch screens are widely used in electronic devices, such as cellular phones. Although useful, touch screens are prone to misoperation due to inadvertent contact with, for example, a user's ear during phone calls. What is needed is to provide an electronic device with extra touch screen locking functions for the touch screen thereof.

### BRIEF DESCRIPTION OF THE DRAWINGS

FIG. 1 is a block diagram of an electronic device in accordance with an embodiment of the present invention.

FIG. 2 is a flowchart of a touch screen locking method, in accordance with another embodiment, applied to the electronic device of FIG. 1.

### DETAILED DESCRIPTION

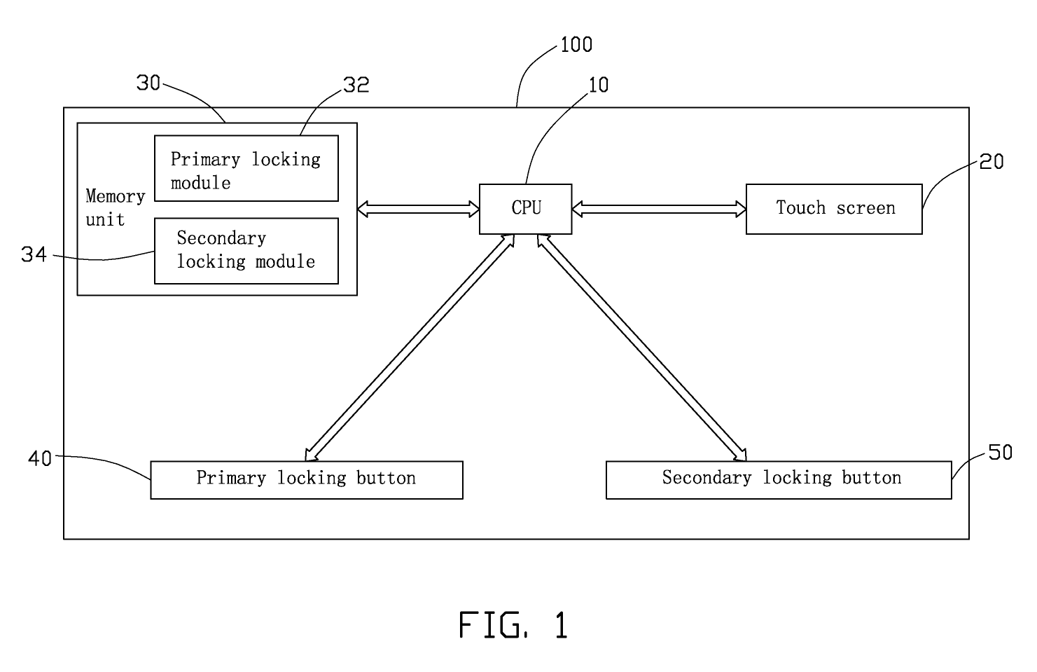

Referring to FIG. 1, an electronic device 100, which may be a cellular phone, in accordance with an embodiment of the present invention includes a central processing unit (CPU) 10, a touch screen 20, a memory unit 30, a primary locking button 40, and a secondary locking button 50. The memory unit 30 includes a primary locking module 32 and a secondary locking module 34. The electronic device 100 may also include other peripheral devices, such as an antenna, a keyboard, and a speaker.

The primary locking module 32 is used for storing a primary locking program. Operation of the primary locking button 40 causes the CPU 10 to instruct the primary locking module 32 to activate the primary locking program, and then the touch screen 20 switches between the unlocked status and locked status. When the touch screen 20 is locked, it cannot be operated. When the touch screen 20 is unlocked, it can be operated. During certain operations, for example during a phone call, the touch screen 20 is forced into unlocked status and operating the primary locking button 40 cannot lock the touch screen 20.

The secondary locking module 34 is used for storing a secondary locking program. Operation of the secondary locking button 50 causes the CPU 10 to instruct the secondary locking module 34 to activate the secondary locking program, and then the touch screen 20 is changed from the unlocked status to the locked status. During the certain operations, for example during a phone call, the touch screen 20 can be locked by operating the secondary locking button 50.

In this embodiment, the primary locking button 40 and the secondary locking button 50 are buttons arranged on the electronic device 100 in addition to keys of a keypad, but in other embodiments, functions of one or both of the locking buttons 40, 50 may be accomplished through use of keys of a keypad.

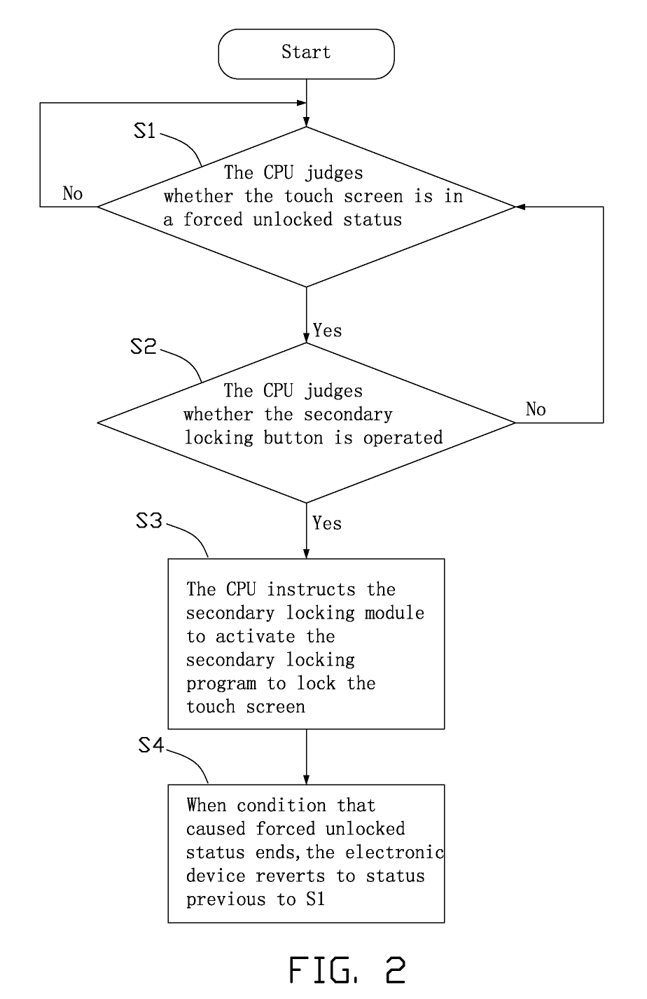

Referring also to FIG. 2, a touch screen locking method of the electronic device 100 in accordance with another embodiment of the present invention includes the following steps.

S1: The CPU 10 judges whether the touch screen 20 of the electronic device 100 is in a forced unlocked status. If no, repeat S1, if yes go to S2.

S2: The CPU 10 judges whether the secondary locking button 50 is operated. If no, go to S1, if yes go to S3.

S3: The CPU 10 instructs the secondary locking module 32 to activate the secondary locking program to lock the touch screen 20.

S4: When condition that caused forced unlocked status ends, the electronic device 100 reverts to status previous to S1.

For example, when the touch screen 20 of the electronic device 100, such as a cellular phone, is locked by operating the primary locking button 40, if the phone is performing a function when a phone call comes in, the touch screen 20 is forced into unlocked status and operating the primary locking button 40 cannot lock the touch screen 20. As a result, a user can operate the touch screen 20 during the phone call, and a misoperation may be caused to the touch screen 20 by the user's ear or finger or other things. At this time, the user can operate the secondary locking button 50 to lock the touch screen 20, and therefore preventing misoperation of the touch screen 20 effectively.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electronic device comprising:
a central processing unit (CPU);
a touch screen capable of being locked and being unlocked;
a locking module configured for storing a locking program; and
a locking button;
upon a condition that the touch screen is forced into an unlocked status, operation of the locking button capable of causing the CPU to instruct the locking module to activate the locking program to lock the touch screen.

2. The electronic device as claimed in claim 1, wherein the electronic device is a cellular phone.

3. The electronic device as claimed in claim 2, wherein the touch screen is forced into an unlocked status when the electronic device is performing a function and a phone call comes in.

4. The electronic device as claimed in claim 3, wherein the locking button is a key of a keypad of the electronic device.

5. An electronic device comprising:
a central processing unit (CPU);
a touch screen capable of being locked and being unlocked;
a primary locking module configured for storing a primary locking program;
a secondary locking module configured for storing a secondary locking program;
a primary locking button; and
a secondary locking button;
wherein operation of the primary locking button is capable of causing the CPU to instruct the primary locking module to activate the primary locking program to switch between an unlocked status and a locked status for the touch screen;
upon a condition that the touch screen is forced into an unlocked status, the touch screen cannot be locked by operating the primary locking button;
upon a condition that the touch screen is forced into an unlocked status, operation of secondary locking button is capable of causing the CPU to instruct the secondary locking module to activate the secondary locking program to lock the touch screen.

6. The electronic device as claimed in claim 5, wherein the primary and secondary locking buttons are buttons arranged on the electronic device.

7. The electronic device as claimed in claim 5, wherein the electronic device is a cellular phone.

8. The electronic device as claimed in claim 7, wherein the touch screen is forced into an unlocked status when the electronic device is performing a function and a phone call comes in.

9. The electronic device as claimed in claim 8, wherein the secondary locking button is a key of a keypad of the electronic device.

10. A touch screen locking method comprising:
providing an electronic device according to claim 5;
determining whether the touch screen of the electronic device is in a forced unlocked status;
upon a condition that the touch screen of the electronic device is in a forced unlocked status, judging whether the secondary locking button is operated;
upon a condition that the secondary locking button is operated, instructing the secondary locking module to activate the secondary locking program to lock the touch screen;
upon a condition that the secondary locking button is not operated, performing the step of determining unlocked status;

11. The touch screen locking method as claimed in claim 10, wherein the electronic device is a cellular phone.

12. The touch screen locking method as claimed in claim 11, wherein the touch screen is forced into an unlocked status when the electronic device is performing a function and a phone call comes in.

13. The touch screen locking method as claimed in claim 12, wherein the secondary locking button is a key of a keypad of the electronic device.

14. The touch screen locking method as claimed in claim 10, further comprising:
upon a condition that caused forced unlocked status ends, reverting the electronic device to the previous status before first performing the step of determining unlocked status.
